(19) United States
(12) Patent Application Publication
(10) Pub. No.: US 2008/0071199 A1
(43) Pub. Date: Mar. 20, 2008

(54) Adjustable limb exerciser

(76) Inventor: Huan-Ping Wu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/518,454

(22) Filed: Sep. 11, 2006

(51) Int. Cl. A63B 15/02; A61H 1/02; A63B 71/00; A61H 1/00

(52) U.S. Cl. 601/23; 482/1; 601/27

(57) ABSTRACT

An adjustable limb exerciser includes a relay securable on the circuit board to electrically connect to the motor, resistors electrically connected to the relay to provide different resistance to hinder the motor from operation and an adjusting knob securable on the casing to direct connection between the relay and the resistors. A heat dissipating plate is mounted adjacent to the resistors to dissipate heat from the resistors.

### BACKGROUND OF THE INVENTION

1. Field of the Invention

The present invention relates to an adjustable limb exerciser, and more particularly to an adjustable limb exerciser to still allow the user to exercise limbs when the power is off.

2. Description of the Prior Art

Limb exercisers are already available on the market and divided into two categories: one is for normal people and the other is for disabled people. For example, if a healthy person is trying to work out his/her legs, the person is able to use such as a bicycle exerciser. The bicycle exerciser is able to provide a resistance to the user so that when the user is exercising, the force trying to overcome the resistance builds up muscles on the legs. If the user is trying to work on his/her arms, the user is able to place both arms on a driving rod which extends through an idle wheel in the exerciser. Resistance is provided to the user when the idle wheel is rotated via rotation of the driving rod as well as a conveying belt which is mounted between the idle wheel and the driving rod. This kind of exerciser is called the passive initiation exerciser where the user has to apply a force to drive the exerciser.

Another exerciser is called the active initiation exerciser where the exerciser is able to drive itself via power so that if the user's both hands or legs are placed on the exerciser of this kind, the exerciser is able to drive the user's arms or legs to move periodically. This kind of exerciser is aimed at persons who are unable to move their arms or legs and need rehabilitation. Therefore, once the arms or legs are placed on the exerciser, movement of the exerciser helps the user work on the muscle that is weak or damaged. As a result of this exerciser, the disabled person is able to gradually regain his own initiation of movement. However, to those who are healthy, the active initiation exerciser is not suitable for them because these users are perfectly in good physical shape and capable of controlling movement of their limbs. Therefore, there is no interchange between the active initiation exerciser and passive initiation exerciser.

To a family which has healthy residences and disabled residences, it seems necessary to have both exercisers to provide suitable exercise to both users. It will be a waste in both money and space if two different exercisers yet have the similar working functions are both purchased. Especially, it is not afforded to spare a space for these two different exercisers in metropolitan areas.

To overcome the shortcomings, the present invention tends to provide an improved exerciser to mitigate the aforementioned problems.

### SUMMARY OF THE INVENTION

The primary objective of the present invention is to provide an improved adjustable limb exerciser to enable a healthy user and a disable user to work on the muscles as required.

In order to accomplish the objective, the exerciser of the present invention includes a casing, a driving rod extending through the casing, a motor received in the casing and having the driving rod extending through one end of the motor, a circuit board received inside the casing and electrically connected to the motor, a relay electrically mounted on the circuit board and resistors electrically connected to the relay such that when the power to the exerciser is on, the relay controls rotation of the motor and when the power is off, the relay electrically connects to one of the resistors to allow the selected resistor to consume the electricity generated by the rotation of the motor.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the adjustable limb exerciser of the present invention;

FIG. 2 is a perspective view of the adjustable limb exerciser in a different embodiment;

FIG. 3 is a schematic side plan view showing the internal structure of the exerciser of the present invention;

FIG. 4 is an enlarged side plan view showing the components on the circuit board; and

FIG. 5 is a diagram showing the connection between the resistors and the relay of the present invention.

### DETAILED DESCRIPTION OF THE PREFERRED EMBODIMENT

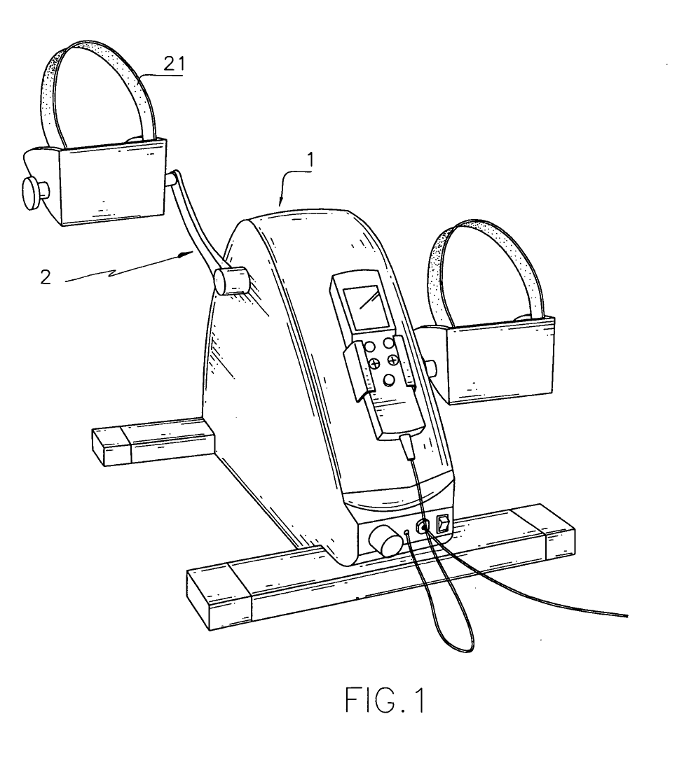

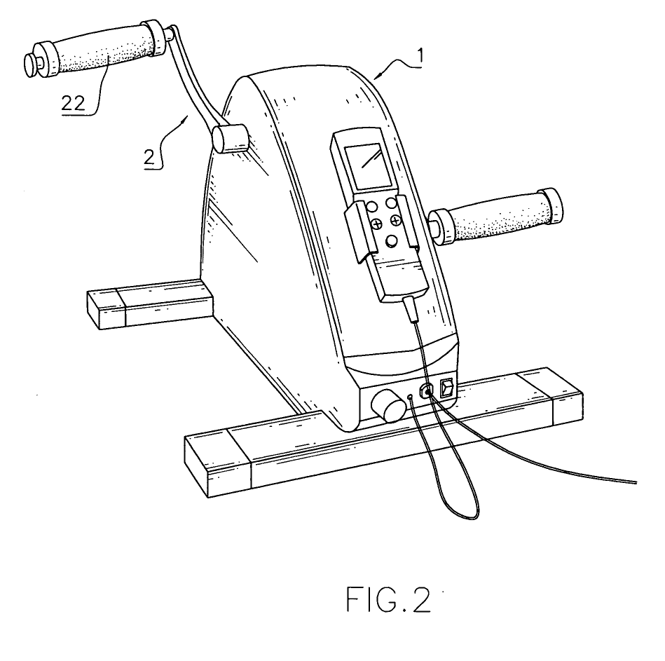

With reference to FIGS. 1 and 2, it is noted that the adjustable limb exerciser in accordance with the present invention includes a casing (1) and a driving rod (2) extending through the casing (1) and having a foot clamp (21) mounted on two opposed ends of the driving rod (2) to receive a user's both legs or a handle (22) mounted on two opposed ends of the driving rod (2) to allow the user's both hands to grasp the handles (22) to drive the driving rod (2) relative to the casing.

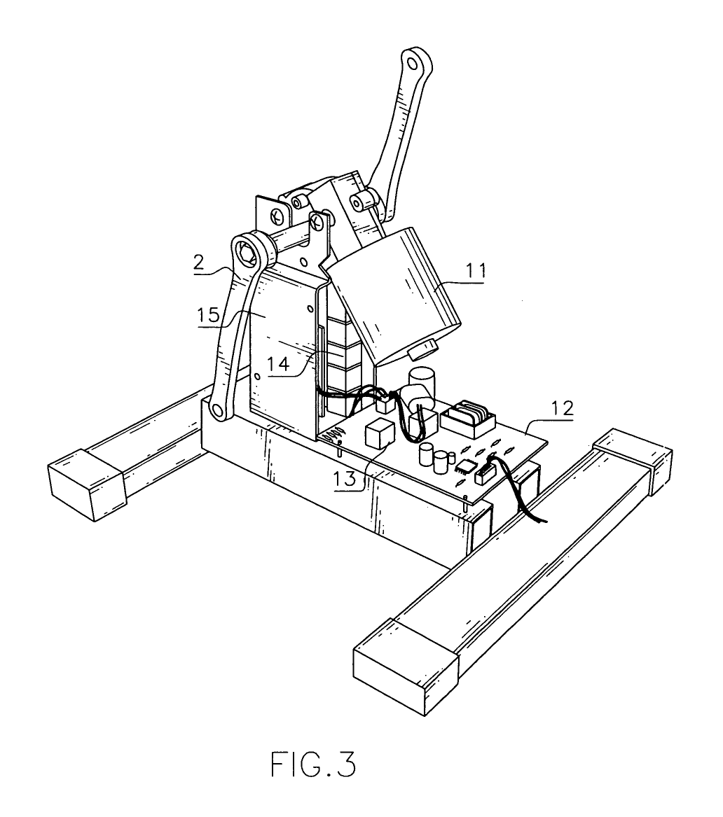

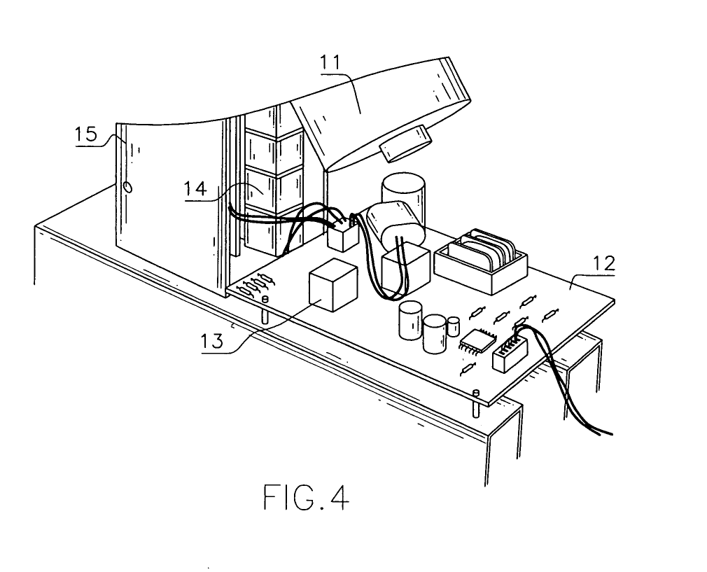

With reference to FIGS. 3 and 4, it is noted that inside the casing (1), there is provided with a motor (11) through which the driving rod (2) extends, a circuit board (12) electrically connected to the motor (11) to control movement of the motor (11), a relay (13) electrically connected to the circuit board (12), resistors (14) electrically connected to the relay (13) and a heat dissipating plate (15) mounted adjacent to the resistors (14) to dissipate heat from the resistors (14).

When the exerciser of the present invention is in operation, it functions exactly the same as that of the active initiation exerciser. That is, after power is provided to drive the motor (11) to rotate, the operation of the motor (11) drives the driving rod (2) to rotate such that a disabled user is able to use the rotation of the driving rod (2) to rehabilitate muscles. However, when the power is off, the user can still use the exerciser of the present invention to exercise.

After the power is off, the relay (13) connects the circuit inside the circuit board (12) to the resistors (14) and a healthy user is able to use an adjusting knob (10) mounted on the casing (1) to select a suitable one of the resistors (14). Then the user is able to rotate the driving rod (2) to use the motor (11) as a generator. Due to the resistance from the selected resistor (14), the strength from the user trying to overcome the resistance of the selected resistor (14) accomplishes the goal of exercise.

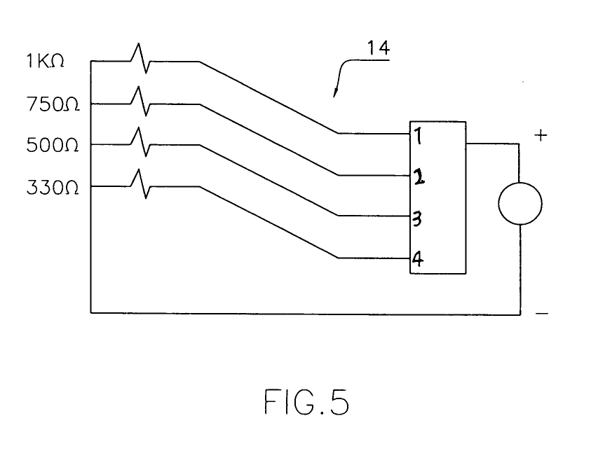

With reference to FIG. 5, it is noted that when the user selects a suitable resistor (14), the resistance provided to the motor (11) varies. Accordingly, the strength to overcome the resistance varies as well. Thus the exerciser of the present invention is able to suit both users. Furthermore, it is noted that when power is shut off, the motor (11) functions as a generator and a voltage is produced when the generator (the motor (11)) is activated.

V=I×R→I=V/R (1)

P=I×V=V×V/R (2)

From equation (2), it is noted that when the resistance is in inverse proportion to power the smaller the resistance, the larger the power. When voltage is generated due to the activation of the motor (11), adjustment of the resistance results in different work. Thus the smaller the resistance is, the larger the power is.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In an adjustable limb exerciser having a casing, a motor received inside the casing, a driving rod extending through the motor and the casing to move with the motor and a circuit board received inside the casing to electrically connect to the motor so as to control movement of the motor, wherein the improvement comprises:
a relay is securable on the circuit board to electrically connect to the motor; and
resistors are electrically connected to the relay to provide different resistance to hinder the motor from operation,
whereby the exerciser is able to function with provision of power where the motor operates to drive the driving rod to rotate and the exerciser is able to function without provision of power where the resistance from a selected resistor hinders the motor from operation, which is a result of rotation of the driving rod drives the motor to operate.

2. The exerciser as claimed in claim 1 further comprising a heat dissipating plate mounted adjacent to the resistors to dissipate heat from the resistors.

3. The exerciser as claimed in claim 2 further comprising an adjusting knob securable on the casing to direct connection between the relay and the resistors.
